(19) United States
(12) Patent Application Publication
(10) Pub. No.: US 2008/0138147 A1
(43) Pub. Date: Jun. 12, 2008

(54) ADJOINING EXPANSION STRUCTURE EXCELLENT IN DESIGN

(75) Inventor: Shinsuke Miura, Kawasaki-Shi (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC Infrontia Corporation, Kawasaki-shi (JP)

(21) Appl. No.: 11/851,157

(22) Filed: Sep. 6, 2007

(30) Foreign Application Priority Data
Sep. 11, 2006 (JP) 2006-245047

(51) Int. Cl. B23P 11/00; B65D 21/02

(52) U.S. Cl. 403/14

(57) ABSTRACT

In an adjoining expansion structure for coupling adjacent devices together in a coupling direction, the adjoining expansion structure includes grooves which penetrate the adjacent devices in the coupling direction, respectively, and coupling members which are inserted in the grooves and fixed to the adjacent devices, respectively. The coupling members are adapted to engage together in the coupling direction. Each of the coupling members may includes a hook projectable from and retractable into a corresponding one of the adjacent devices and a receiving portion having a form adapted for receiving the hook in the coupling direction.

This application is based upon and claims the benefit of priority from Japanese patent application No. 2006-245047, filed on Sep. 11, 2006, the disclosure of which is incorporated herein in its entirely by reference.

### BACKGROUND OF THE INVENTION

This invention relates to a structure enabling the adjoining expansion of devices (herein this is called an “adjoining expansion structure”).

For example, when stacking a plurality of synthetic resin mold products, the adjoining expansion structure is often required for aligning the respective products and coupling them together.

A first related art will be described with reference to FIGS. 1A to 1C.

As shown in FIG. 1A, a parent device 31 is configured as a rectangular parallelepiped box and an expansion metal fitting 32 is configured as a rectangular plate. The expansion metal fitting 32 is provided with a total of four hooks 32a at two portions near the middle of its rear side and at two portions near rear corners of its left and right sides. The expansion metal fitting 32 is further provided with screw-fixing plate-like portions 32b at two portions near the middle of its front side. Further, holes 32c for insertion of screws are provided near four corners of the expansion metal fitting 32.

As indicated by downward arrows in FIG. 1A, the expansion metal fitting 32 is placed on an upper surface of the parent device 31 and fixed to the parent device 31 by four screws (not shown).

As shown in FIG. 1B, a child device 33 is configured as a rectangular parallelepiped box having the same size as the parent device 31. The child device 33 is provided with hook engaging portions (not shown) at portions corresponding to the four hooks 32a of the expansion metal fitting 32. The child device 33 is further provided with screw holes 33a at two portions near the middle of its front lower portion.

As shown in FIG. 1C, the child device 33 is placed on the expansion metal fitting 32 so that the hook engaging portions of the child device 33 engage the hooks 32a of the expansion metal fitting 32, respectively. Then, two screws 34 are inserted into the two screw-fixing plate-like portions 32b of the expansion metal fitting 32 and threaded into the two screw holes 33a of the child device 33. As a result, the child device 33 is coupled to the parent device 31. The expansion metal fitting 32 is seen between the devices 31 and 33.

A second related art will be described with reference to FIGS. 2A and 2B.

As shown in FIG. 2A, a parent device 41 is made of a synthetic resin and configured as a rectangular parallelepiped box. Hook engaging holes 41a are formed at three portions on one side of the parent device 41. A child device 42 is made of a synthetic resin and configured as a rectangular parallelepiped box. Hooks 42a are formed to project at three portions on one side of the child device 42.

The child device 42 is coupled to the parent device 41 as shown in FIG. 2B. Since an expansion metal fitting is not used between the devices 41 and 42, the design is not marred. However, since the hooks 42a and the hook engaging holes 41a are each part of the mold product, the structural strength is insufficient.

A third related art will be described (see, e.g. Japanese Unexamined Utility Model Application Publication (JP-U) No. Sho 62-70480). A plate member of a coupler has four pairs of L-shaped pawls and a pair of fixing pieces. After fitting the L-shaped pawls into coupling surfaces of two devices to be coupled together, the fixing pieces are screwed to the devices, respectively.

A fourth related art will be described (see, e.g. Japanese Unexamined Utility Model Application Publication (JP-U) No. Hei 04-10376). Using feet of an upper device housing and foot receivers of a lower device housing as positioning guide means, the housings are stacked together. In this event, L-shaped metal fittings of the upper device housing are brought into engagement with U-shaped metal fittings of the lower device housing, respectively. Then, fixing screws are respectively inserted into holes of the U-shaped metal fittings and holes of the L-shaped metal fittings and then tightened, so that the housings are fixedly coupled together.

A fifth related art will be described (see, e.g. Japanese Unexamined Patent Application Publication (JP-A) No. 2002-284168). When grips of a container box are respectively placed in grip cutout portions, engaging pawls are respectively brought into engagement with engaging rods of another container box located below. Accordingly, the two container boxes are coupled together. When the grips are raised from the grip cutout portions, the engaging pawls release the engagement with the engaging rods. Accordingly, the two container boxes are released from the coupling.

The first to fifth related arts each have at least one of the following drawbacks.

1. Since an expansion metal fitting coupling together a parent device and a child device is seen from the outside, the design properties of the devices are reduced.

2. The strength of a structure coupling together a parent device and a child device is weak.

3. The structure coupling together a parent device and a child device is complicated.

### SUMMARY OF THE INVENTION

It is therefore an exemplary object of this invention to provide an adjoining expansion structure that is excellent in design, strong, and simple.

Other objects of the present invention will become clear as the description proceeds.

According to an exemplary aspect of the present invention, there is provided an adjoining expansion structure for coupling adjacent devices together in a coupling direction, the adjoining expansion structure comprising grooves which penetrate the adjacent devices in the coupling direction, respectively, and coupling members which are inserted in the grooves and fixed to the adjacent devices, respectively, wherein the coupling members are adapted to engage together in the coupling direction.

### BRIEF DESCRIPTION OF THE DRAWINGS

FIG. 1A is a perspective view showing a state before an expansion metal fitting is fixed to a parent device in a first related art;

FIG. 1B is a perspective view showing a state before a child device is fixed to the expansion metal fitting fixed to the parent device;

FIG. 1C is a front view showing a state where the parent device and the child device are coupled together;

FIG. 2A is a perspective view showing a state before a parent device and a child device are coupled together in a second related art;

FIG. 2B is a plan view showing a state where the parent device and the child device are coupled together;

FIG. 3A is a perspective view showing a state before a parent device and a child device are coupled together using an adjoining expansion structure according to a first exemplary embodiment of this invention;

FIG. 3B is an exploded perspective view of the parent device;

FIG. 3C is a perspective view showing a state where the parent device and the child device are coupled together;

FIG. 3D is a perspective view showing a state where two expansion metal fittings included in the adjoining expansion structure are in engagement with each other;

FIG. 4A is a perspective view showing a state where a hook and a screw receiving plate project from a base plate in the expansion metal fitting;

FIG. 4B is a front view showing the same state;

FIG. 4C is a left side view showing the same state;

FIG. 4D is a perspective view showing a state where the hook and the screw receiving plate are retracted in the base plate in the expansion metal fitting;

FIG. 5 is a perspective view of a parent device provided with an adjoining expansion structure according to a second exemplary embodiment of this invention; and

FIG. 6 is a perspective view of a pair of expansion metal fittings included in the adjoining expansion structure.

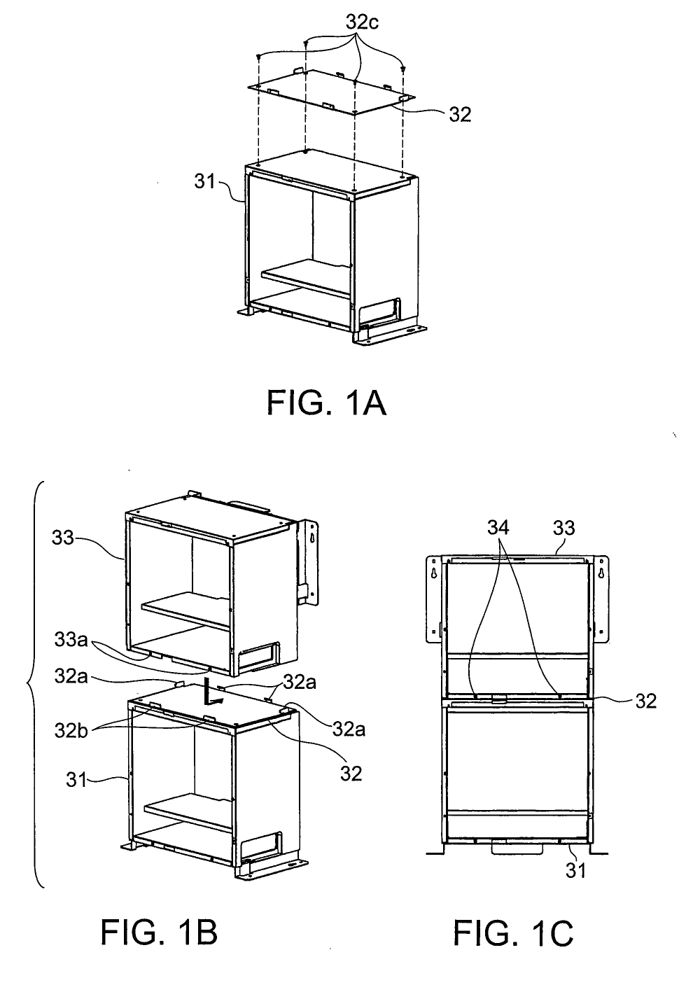

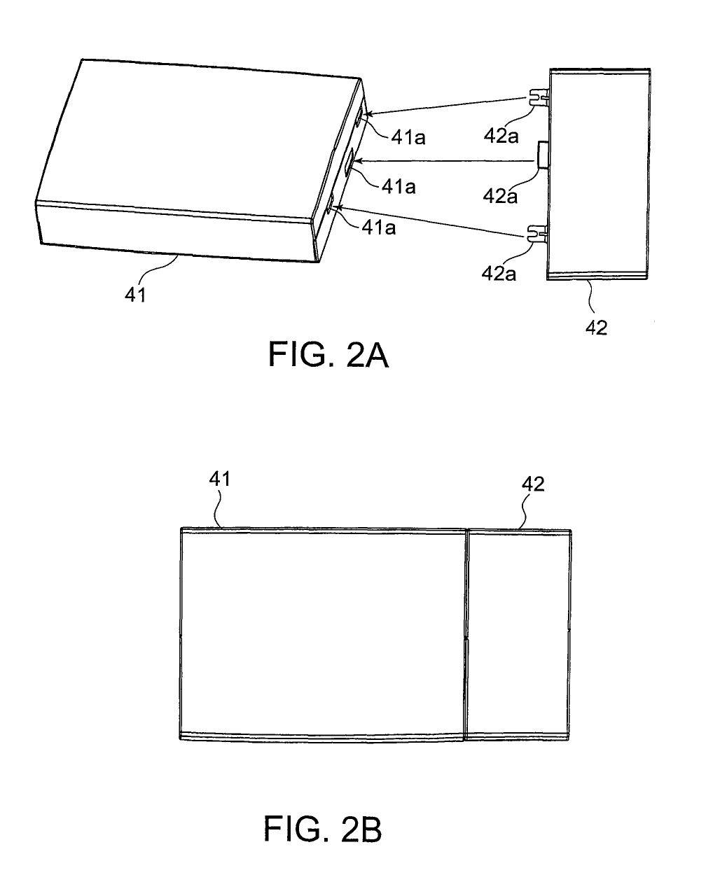

### DESCRIPTION OF THE EXEMPLARY EMBODIMENTS

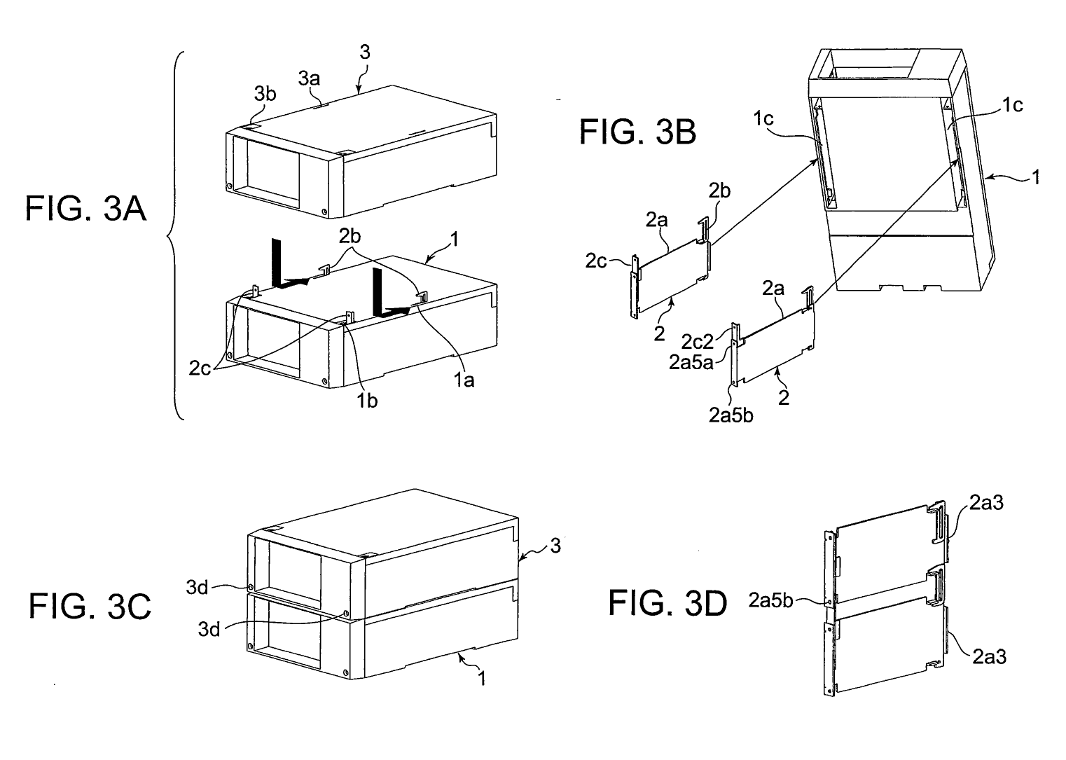

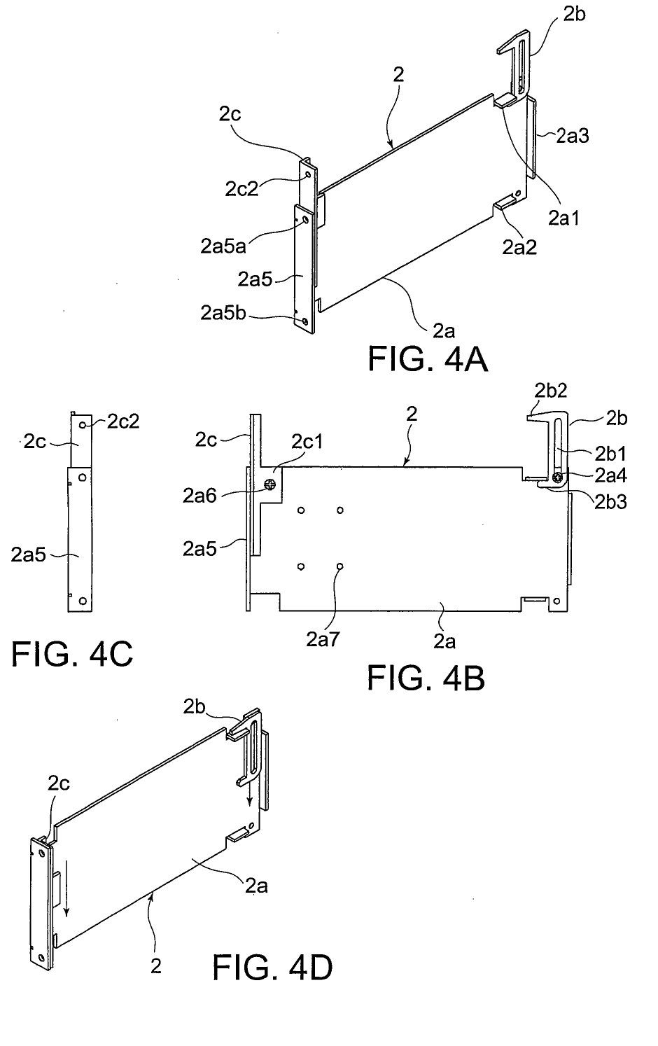

Referring to FIGS. 3A to 3D and 4A to 4D, a description will be given of an adjoining expansion structure according to a first exemplary embodiment of this invention.

A parent device 1 is configured as a rectangular parallelepiped box. As will be described in detail later, tip portions of hooks 2b and screw receiving plates 2c of a pair of (left and right) expansion metal fittings 2 project from openings 1a and 1b provided on both left and right sides of an upper surface of the parent device 1. The expansion metal fitting 2 on the left side and the expansion metal fitting 2 on the right side have shapes symmetrical with each other. As shown in FIG. 3B, grooves 1c for insertion of the pair of (left and right) expansion metal fittings 2 are provided on both left and right sides of the bottom of the parent device 1 near the front side thereof.

A child device 3 is configured as a rectangular parallelepiped box having the same size as the parent device 1. Openings 3a and 3b are provided on both left and right sides of an upper surface of the child device 3.

A description will be given of the sequence of stacking the child device 3 on the parent device 1 and coupling them together.

At first, the pair of expansion metal fittings 2 included in the adjoining expansion structure are respectively inserted into the pair of grooves 1c of the parent device 1 and fixed thereto. In this event, the hook 2b and the screw receiving plate 2c of each expansion metal fitting 2 project from its base plate 2a as shown in FIGS. 4A to 4C.

Then, another pair of expansion metal fittings 2 are respectively inserted into a pair of grooves (not shown) of the child device 3 and fixed thereto. In this event, since the child device 3 is the uppermost device in the expansion, a hook 2b and a screw receiving plate 2c of each expansion metal fitting 2 are retracted in its base plate 2a as shown in FIG. 4D.

Subsequently, by moving the lower surface of the child device 3 relative to the upper surface of the parent device 1 according to a pair of L-shaped arrows in FIG. 3A, the state shown in FIG. 3C is reached. In this state, the hooks 2b of the expansion metal fittings 2 fixed to the parent device 1 are respectively in engagement with hook receiving portions 2a2 of the expansion metal fittings 2 fixed to the child device 3.

Further, in this state, a screw (not shown) and a driver (not shown) are inserted into each of through holes 3d provided on both sides of the front lower portion of the child device 3. Then, by rotating the driver, the screw is threaded into a screw hole 2a5b of each of the expansion metal fittings 2 fixed to the child device 3 and a screw hole 2c2 of the screw receiving plate 2c of each of the expansion metal fittings 2 fixed to the parent device 1. Accordingly, the child device 3 is coupled to the parent device 1.

The expansion metal fitting 2 will be described in detail with reference to FIGS. 4A to 4D.

As shown in FIG. 4A, the expansion metal fitting 2 includes a generally rectangular base plate 2a, a hook 2b held on one end side of the base plate 2a so as to be slidable parallel to a short side thereof, and a screw receiving plate 2c held on the other end side of the base plate 2a so as to be slidable parallel to a short side thereof.

The base plate 2a has hook receiving portions 2a1 and 2a2 on both upper and lower sides thereof at portions each located near one end of each of long sides of the base plate 2a, a bent portion 2a3 along one of the short sides thereof, and a guide screw 2a4 near an upper portion of the same short side. Further, the base plate 2a has a bent portion 2a5 along the other short side and the bent portion 2a5 is provided with screw holes 2a5a and 2a5b near both upper and lower ends thereof.

The hook 2b has an elongated hole 2b1 extending in its sliding direction, a projection 2b2 at an upper-end side portion thereof, and a projection 2b3 at a lower-end side portion thereof.

As shown in FIGS. 4A to 4C, the screw receiving plate 2c is bent into a generally L-shape, formed with a rectangular convex portion 2c1 near the middle thereof, and provided with a screw hole 2c2 near an upper end thereof.

FIGS. 4A to 4C show the state where the hook 2b and the screw receiving plate 2c project upward from the base plate 2a. An expansion metal fitting 2 fixed to a device other than the uppermost device in the expansion is used in this state. The lower end of the elongated hole 2b1 of the hook 2b abuts against the guide screw 2a4 and the projection 2b3 of the hook 2b abuts against the upper hook receiving portion 2a1 of the expansion metal fitting 2. The projection 2b2 of the hook 2b engages the hook receiving portion 2a2 of the expansion metal fitting 2 fixed to the upper child device 3.

A description will be given of a method of retracting the hook 2b and the screw receiving plate 2c in the base plate 2a.

When the hook 2b is pushed downward by fingers, the hook 2b slides, while being guided by the guide screw 2a4 and the bent portion 2a3, until the projection 2b2 abuts against the hook receiving portion 2a1, and then stops at the position indicated in FIG. 4D.

Further, when the screw receiving plate 2c is pushed downward by fingers, after a screw 2a6 fixing the screw receiving plate 2c to the base plate 2a is removed using a driver, until the screw hole 2c2 coincides with the screw hole 2a5a of the base plate 2a, the screw receiving plate 2c slides while being guided by the bent portion 2a5 and reaches the position indicated in FIG. 4D. A screw (not shown) is threaded into the screw hole 2a5a and the screw hole 2c2 using the driver, thereby fixing the screw receiving plate 2c to the base plate 2a.

If the hook 2b can be fixed relative to the base plate 2a at its projected position and its retracted position by the guide screw 2a4, it is possible to omit the hook receiving portion 2a1.

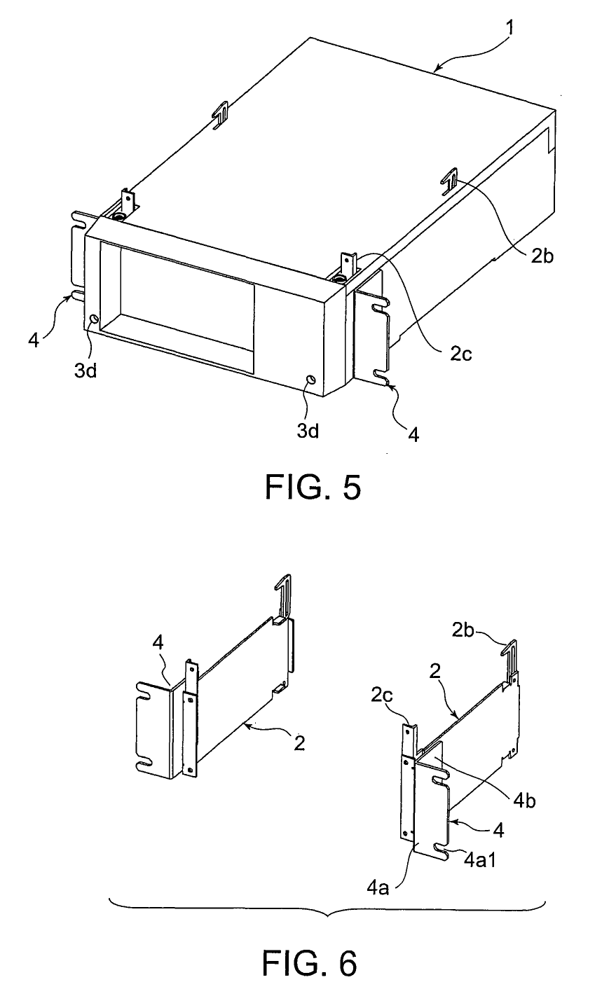

Referring to FIGS. 5 and 6, a description will be given of an adjoining expansion structure according to a second exemplary embodiment of this invention. The same reference symbols are assigned to the same or like portions, thereby omitting explanation thereof.

As shown in FIG. 6, 19-inch rack attaching metal fittings 4 are directly attached to the outer sides of left and right expansion metal fittings 2. Each of the rack attaching metal fittings 4 is formed by perpendicularly bending a plate and includes an attaching portion 4a to be attached to a rack and a fixing portion 4b to be fixed to the expansion metal fitting 2. The attaching portion 4a is formed with cutout portions 4a1 on both sides of its tip surface. The fixing portion 4b is fixed to the expansion metal fitting 2 by threading screws (not shown) into four screw holes 2a7 formed in a base plate 2a of the expansion metal fitting 2, as shown in FIG. 4B, through openings (not shown) provided on each of the left and right sides of a parent device 1. The rack attaching metal fitting 4 can also be used as an attaching metal fitting for attachment to equipment such as a wall.

In the adjoining expansion structure according to each of the first and second embodiments, two expansion metal fittings 2 are provided for each of the parent device 1 and the child device 3. However, depending on the size, strength, or structure of the parent device 1 and the child device 3, the design can be changed so that only one expansion metal fitting 2 is provided for each of the parent device 1 and the child device 3 on its one side (i.e. left side, right side, front side, rear side, upper side, or lower side) or in its middle.

The third exemplary embodiment of the invention is an adjoining expansion structure, wherein each of the coupling members comprises a hook which is projectable from and retractable into a corresponding one of the adjacent devices and a receiving portion having a form adapted for receiving the hook in the coupling direction.

The fourth exemplary embodiment of the invention is an adjoining expansion structure, wherein each of the first coupling members further comprises an additional receiving portion capable of receiving the hook in the coupling direction.

The fifth exemplary embodiment of the invention is an adjoining expansion structure, wherein each of the coupling members further comprises a base plate which is placed in each of the grooves and has a screw hole and a screw receiving plate which is connected to the base plate, wherein the screw receiving plate is projectable from and retractable into the corresponding one of the adjacent devices, and wherein the screw receiving plate has a screw hole having a form adapted for being screwed together with the screw hole of the base plate.

The sixth exemplary embodiment of the invention is an adjoining expansion structure, wherein the screw receiving plate is placed apart from the hook in a direction perpendicular to the coupling direction.

The seventh exemplary embodiment of the invention is an adjoining expansion structure, wherein the coupling members comprise a first and a second coupling metal fittings, each of the first and second coupling metal fittings has, on one end side thereof, a hook held so as to be projectable and retractable and one or two hook receiving portions and has, on the other end side thereof, a screw receiving plate held so as to be projectable and retractable and a first and a second screw hole, the screw receiving plate has a third screw hole, the hook of the first coupling metal fitting, in its projected state, engages one of the hook receiving portions of the second coupling metal fitting, the screw, in a projected state of the screw receiving plate of the first coupling metal fitting, is threaded into the second screw hole of the second coupling metal fitting and the third screw hole of the screw receiving plate of the first coupling metal fitting using the driver, and the screw, in a retracted state of the screw receiving plate of the first coupling metal fitting, is threaded into the first screw hole of the first coupling metal fitting and the third screw hole of the screw receiving plate of the first coupling metal fitting using the driver.

The eighth exemplary embodiment of the invention is an adjoining expansion structure, wherein each of the adjacent devices as, in addition to the groove and the through hole, another groove and another through hole, the groove and the another groove being located near both sides of each of the adjacent devices and the through hole and the another through hole being located near both sides of each of the adjacent devices.

The ninth exemplary embodiment of the invention is an adjoining expansion structure, wherein the hook of the first coupling metal fitting has an elongated hole for guiding at the time of projection and retraction thereof and a projection for engaging the one of the hook receiving portions of the second coupling metal fitting.

The tenth exemplary embodiment of the invention is an adjoining expansion structure, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

The eleventh exemplary embodiment of the invention is an adjoining expansion structure, wherein the hook of the first coupling metal fitting has an elongated hole for guiding at the time of projection and retraction thereof, a first projection for engaging the other of the hook receiving portions of the first coupling metal fitting in a retracted state of the hook of the first coupling metal fitting, and a second projection for engaging the other of the hook receiving portions of the first coupling metal fitting in the projected state of the hook of the first coupling metal fitting.

The twelfth exemplary embodiment of the invention is an adjoining expansion structure, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

The thirteenth exemplary embodiment of the invention is an adjoining expansion structure, wherein each of the screw receiving plates is bent into a generally L-shape, is detachably fixed to a base plate of the corresponding one of the first and second coupling metal fittings, and has the third screw hole near one end thereof.

The fourteenth exemplary embodiment of the invention is an adjoining expansion structure, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

The fifteenth exemplary embodiment of the invention is an adjoining expansion structure, wherein each of the adjacent devices is formed with openings on both sides thereof, attaching metal fittings are respectively fixed to the first and second coupling metal fittings through the openings, and each of the attaching metal fittings is formed by perpendicularly bending a plate and has an attaching portion for attachment to equipment and a fixing portion for fixation to the corresponding one of the first and second coupling metal fittings.

The sixteenth exemplary embodiment of the invention is an adjoining expansion structure, wherein the adjacent devices have the same size as each other.

The exemplary advantages according to the invention are:

1. Since expansion metal fittings coupling a plurality of devices together are not seen from the outside, the total design properties of the devices are improved;

2. Since the expansion metal fittings coupling the devices together are each configured as having a hook and a screw receiving plate, the coupling structure is strong and stable;

3. The coupling structure is achieved by inserting and fixing the expansion metal fittings in grooves of the respective devices and thus is simple and low in cost; and

4. The devices can be easily coupled together by rotating a screw using a driver.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An adjoining expansion structure for coupling adjacent devices together in a coupling direction, the adjoining expansion structure comprising:
grooves which penetrate the adjacent devices in the coupling direction, respectively; and
coupling members which are inserted in the grooves and fixed to the adjacent devices, respectively;
wherein the coupling members are adapted to engage together in the coupling direction.

2. The adjoining expansion structure according to claim 1, wherein each of the coupling members comprises:
a hook which is projectable from and retractable into a corresponding one of the adjacent devices; and
a receiving portion having a form adapted for receiving the hook in the coupling direction.

3. The adjoining expansion structure according to claim 2, wherein each of the first coupling members further comprises an additional receiving portion capable of receiving the hook in the coupling direction.

4. The adjoining expansion structure according to claim 2, wherein each of the coupling members further comprises:
a base plate which is placed in each of the grooves and has a screw hole; and
a screw receiving plate which is connected to the base plate;
wherein the screw receiving plate is projectable from and retractable into the corresponding one of the adjacent devices, and
wherein the screw receiving plate has a screw hole having a form adapted for being screwed together with the screw hole of the base plate.

5. The adjoining expansion structure according to claim 4, wherein the screw receiving plate is placed apart from the hook in a direction perpendicular to the coupling direction.

6. The adjoining expansion structure according to claim 1, wherein:
the coupling members comprise a first and a second coupling metal fittings,
each of the first and second coupling metal fittings has, on one end side thereof, a hook held so as to be projectable and retractable and one or two hook receiving portions and has, on the other end side thereof, a screw receiving plate held so as to be projectable and retractable and a first and a second screw hole,
the screw receiving plate has a third screw hole,
the hook of the first coupling metal fitting, in its projected state, engages one of the hook receiving portions of the second coupling metal fitting,
the screw, in a projected state of the screw receiving plate of the first coupling metal fitting, is threaded into the second screw hole of the second coupling metal fitting and the third screw hole of the screw receiving plate of the first coupling metal fitting using the driver, and
the screw, in a retracted state of the screw receiving plate of the first coupling metal fitting, is threaded into the first screw hole of the first coupling metal fitting and the third screw hole of the screw receiving plate of the first coupling metal fitting using the driver.

7. The adjoining expansion structure according to claim 6, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

8. The adjoining expansion structure according to claim 6, wherein the hook of the first coupling metal fitting has an elongated hole for guiding at the time of projection and retraction thereof and a projection for engaging the one of the hook receiving portions of the second coupling metal fitting.

9. The adjoining expansion structure according to claim 8, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

10. The adjoining expansion structure according to claim 6, wherein the hook of the first coupling metal fitting has an elongated hole for guiding at the time of projection and retraction thereof, a first projection for engaging the other of the hook receiving portions of the first coupling metal fitting in a retracted state of the hook of the first coupling metal fitting, and a second projection for engaging the other of the hook receiving portions of the first coupling metal fitting in the projected state of the hook of the first coupling metal fitting.

11. The adjoining expansion structure according to claim 10, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

12. The adjoining expansion structure according to claim 6, wherein each of the screw receiving plates is bent into a generally L-shape, is detachably fixed to a base plate of the corresponding one of the first and second coupling metal fittings, and has the third screw hole near one end thereof.

13. The adjoining expansion structure according to claim 12, wherein each of the adjacent devices has, in addition to the groove and the through hole, another groove and another through hole, the groove and the another groove being located near both sides of each of the adjacent devices and the through hole and the another through hole being located near both sides of each of the adjacent devices.

14. The adjoining expansion structure according to claim 13, wherein each of the adjacent devices is formed with openings on both sides thereof, attaching metal fittings are respectively fixed to the first and second coupling metal fittings through the openings, and each of the attaching metal fittings is formed by perpendicularly bending a plate and has an attaching portion for attachment to equipment and a fixing portion for fixation to the corresponding one of the first and second coupling metal fittings.

15. The adjoining expansion structure according to claim 1, wherein the adjacent devices have the same size as each other.
